(19) United States
(12) Patent Application Publication
(10) Pub. No.: US 2019/0238031 A1
(43) Pub. Date: Aug. 1, 2019

(54) ROTATING ELECTRICAL MACHINE WITH AN ANTI-LOOPBACK FLOW ELEMENT EQUIPPED WITH SEALING PLUGS

(71) Applicant: Valeo Equipements Electriques Moteur, Creteil (FR)

(72) Inventors: Fabrice Tauvron, Creteil Cedex (FR); Svetislav Jugovic, Creteil Cedex (FR); Farouk Boudjemai, Creteil Cedex (FR)

(73) Assignee: Valeo Equipements Electriques Moteur, Creteil (FR)

(21) Appl. No.: 16/338,266

(22) PCT Filed: Sep. 29, 2017
(86) PCT No.: PCT/FR2017/052677

§ 371 Date: Mar. 29, 2019

(30) Foreign Application Priority Data
Sep. 30, 2016 (FR) 1659392

(51) Int. Cl. H02K 11/04; H02K 11/05; H02K 5/20

(52) U.S. Cl. CPC H02K 11/048; H02K 11/05; H02K 9/06; H02K 2209/00; H02K 5/20

(57) ABSTRACT

The invention mainly relates to a rotating electrical machine (10), in particular for a motor vehicle, comprising: —a heat sink (58) having at least one receptacle, —an electric module positioned in the receptacle and comprising at least one connection terminal, —a connector (55) comprising at least one track (54) electrically connected to the connection terminal and a receptacle (84) for receiving a connecting means, in particular a head (83) of a screw (74), ensuring the mechanical and electrical connection between the track (54) of the connector (55) and the heat sink (58), and —an anti-loopback air flow element (93) inserted between a bearing (18) of the rotating electrical machine (10) and the connector (55), characterised in that the anti-loopback air flow element (93) comprises at least one sealing plug (101) for the receptacle (84) for the connecting means.

The present invention relates to a rotary electrical machine with an airflow anti-loopback element provided with closure studs. The invention has a particularly advantageous, but non-exclusive, application in the field of alternators, alternator starters and reversible machines for motor vehicles.

In a known manner, a rotary electrical machine comprises a housing, and, inside the housing, a claw rotor which is integral in rotation with a shaft, and a stator which surrounds the rotor with the presence of an air gap.

The rotor comprises two magnet wheels each with a flange with transverse orientation provided on its outer periphery with claws with axial orientation. The claws of the magnet wheels are imbricated relative to one another. A cylindrical core is interposed axially between the flanges of the wheels. This core supports on its outer periphery an excitation coil which is formed around an insulating element interposed radially between the core and the coil.

In addition, the stator comprises a body constituted by a stack of thin metal plates forming a crown, the inner face of which is provided with notches open towards the interior in order to receive phase windings. These windings pass through the notches in the stator body, and form chignons which project on both sides of the stator body. The phase windings are obtained for example from a continuous wire covered with enamel, or from conductive elements in the form of pins connected to one another by welding.

The phase windings are connected electrically to electronic power modules via their phase output. These power modules form a voltage rectifier bridge. Generally, each power module comprises a control unit which can control for example two or three bridge arms, each comprising two rectifier elements constituted for example by transistors of the MOSFET type.

The power modules are integrated in a heat dissipater. Connections between the terminals of the power modules and the tracks of a connector are formed for example by laser welding through connection areas.

The connector is secured on the heat dissipater by means of screws which ensure a mechanical and electrical connection between certain tracks of the connector and the heat dissipater. The subassembly formed by the connector and the heat dissipater is secured on the bearing which is connected electrically to the earth.

The problem with a configuration of this type is that there are exposed tracks and screws which are subjected to different electrical potentials. An airflow anti-loopback element, which prevents the return towards the electronics of the hot air exiting from the electrical machine, also makes it possible to insulate the tracks and screws against the bearing which is connected to the earth, but does not make it possible to insulate them against each other. Consequently, in the case of water retention, saline bridges are created, and accelerate greatly the corrosion of the screws and tracks of the rectifier bridge.

The objective of the invention is to eliminate this disadvantage efficiently by proposing a rotary electrical machine, in particular for a motor vehicle, comprising:
a heat dissipater provided with at least one receptacle;
an electrical module which is positioned in the receptacle, and comprises at least one connection terminal;
a connector comprising at least one track which is connected electrically to the connection terminal, and a receptacle which is designed to receive a connection means, in particular a head of a screw, ensuring a mechanical and electrical connection between the track of the connector and the heat dissipater; and
an airflow anti-loopback element interposed between a bearing of the rotary electrical machine and the connector,
   characterised in that the airflow anti-loopback element comprises at least one stud for closure of the receptacle of the connection means.

The closure studs then close the receptacles of the connection means. Thanks to the presence of the closure studs, the invention thus makes it possible to insulate the connection means, in particular the screw heads of the rectifier bridge, against the corrosive environments. These studs also ensure the retention of the plate on the bearing during steps of assembly of the electrical machine. In addition, taking into account the low degree of modification to be made to the configuration of the airflow anti-loopback element, the invention has little impact on the assembly line of the rotary electrical machine.

According to one embodiment, the closure stud is situated axially between the connector and a body of the airflow anti-loopback element.

According to one embodiment, the closure stud is situated facing the connector.

According to one embodiment, the connector comprises at least one area of welding with the connection terminal of the electrical module, with the airflow anti-loopback element comprising at least one stud for closure of the welding area.

According to one embodiment, the welding area has a receptacle, the said receptacle being closed by a stud for closure of the welding area.

According to one embodiment, the closure stud is made of a resilient material, in particular a polymer material.

According to one embodiment, the closure stud is compressed between the connector and the body of the airflow anti-loopback element.

According to one embodiment, a height of the closure stud in the non-compressed state is greater than a height of the said stud in the compressed state. For example, the height of the closure stud in the non-compressed state is between 20 and 40% greater, in particular 30% greater, than the height of the said stud in the compressed state.

According to one embodiment, a radius of the closure stud is greater than a radius of the receptacle of the connection means.

According to one embodiment, the radius of the closure stud is greater, by a length of between 0.5 and 2 mm, in particular 1.5 mm, than the radius of the receptacle of the connection means.

According to one embodiment, the airflow anti-loopback element is over-moulded on the closure stud.

According to one embodiment, the closure stud is added on and secured on the airflow anti-loopback element.

According to one embodiment, the closure stud is integral with the airflow anti-loopback element, such as to form a bi-material part.

According to one embodiment, the airflow anti-loopback element comprises a plurality of closure studs, which are connected to one another such as to form a seal.

According to one embodiment, the heat dissipater is connected to a positive potential of a battery.

According to one embodiment, the connector comprises a low wall which extends around the receptacle designed to receive the connection means. As a variant, the connector is without a low wall.

According to one embodiment, the closure stud has a hollow form in which the connection means is inserted.

The invention will be better understood by reading the following description and examining the figures which accompany it. These figures are provided purely by way of illustration, and in no way limit the invention.

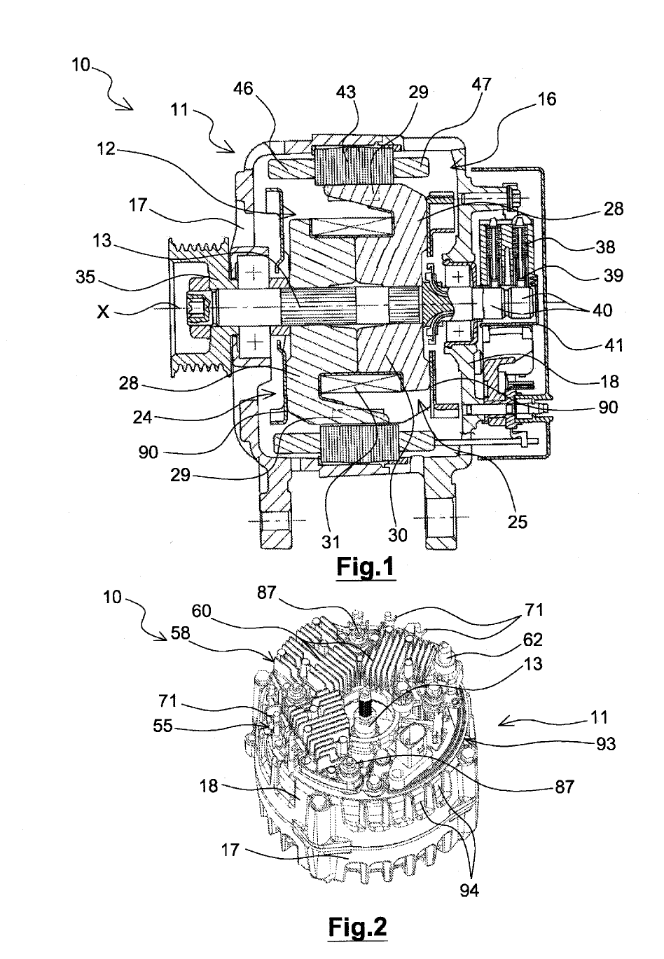

FIG. 1 is a view in longitudinal cross-section of a rotary electrical machine according to the present invention;

FIG. 2 is a view in perspective showing the rear end of the rotary electrical machine according to the present invention;

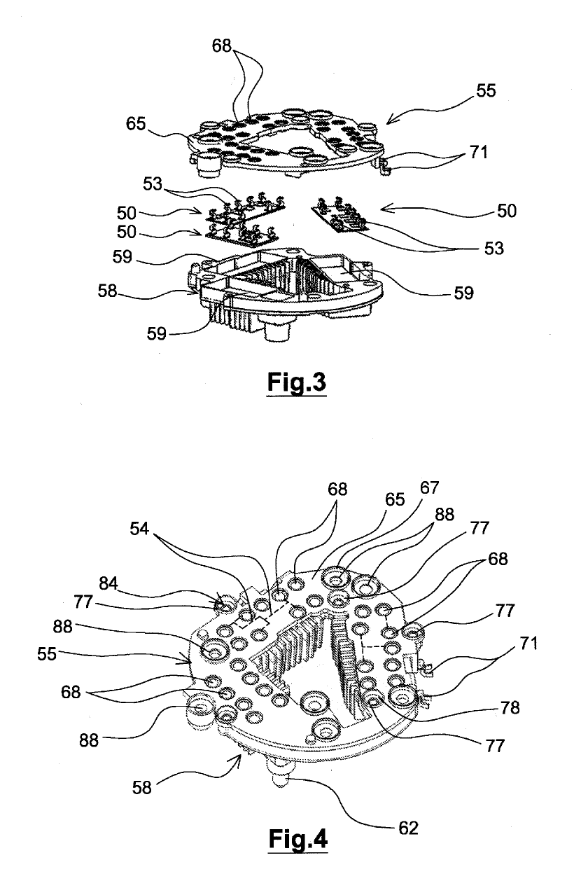

FIG. 3 is an exploded view in perspective of the connector, of the electronic power modules, and of the heat dissipater of the rotary electrical machine according to the present invention;

FIG. 4 is a view in perspective of the subassembly formed by the heat dissipater and the connector of the rotary electrical machine according to the present invention;

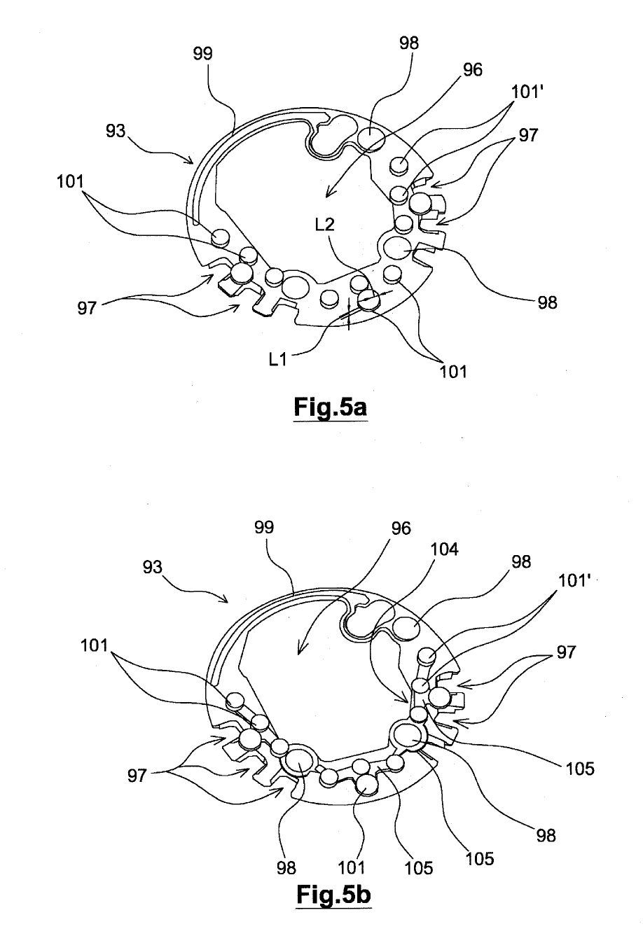

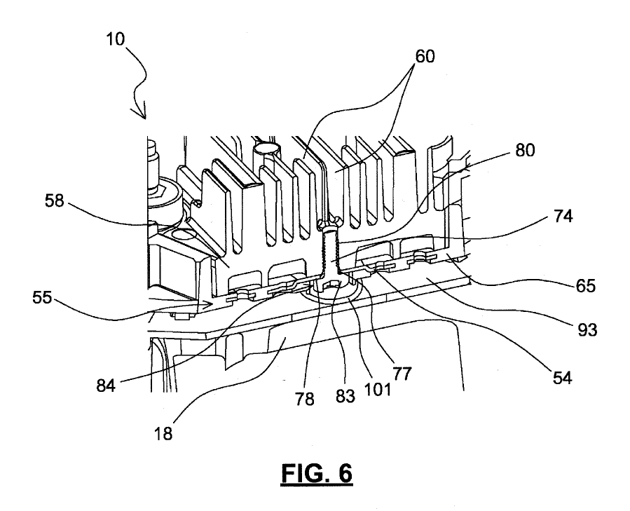

FIGS. 5a and 5b are views in perspective illustrating two embodiments of the closure studs associated with the airflow anti-loopback element according to the present invention;

FIG. 6 is a view in perspective and in cross-section illustrating the positioning of the closure studs relative to the heads of the screws which ensure the securing between the dissipater and the connector according to the present invention.

Elements which are identical, similar or analogous retain the same reference from one figure to another.

FIG. 1 represents a rotary electrical machine, such as a compact polyphase alternator 10, in particular for a motor vehicle. The alternator 10 can transform mechanical energy into electrical energy, and can be reversible. A reversible alternator of this type, known as an alternator-starter, makes it possible to transform electrical energy into mechanical energy, in particular in order to start the thermal engine of the vehicle.

This alternator 10 comprises a housing 11, and inside the housing, a claw rotor 12 fitted on a shaft 13, and a stator 16, which surrounds the rotor 12 with the presence of an air gap between the outer periphery of the rotor 12 and the inner periphery of the stator 16. The axis X according to which the shaft 13 extends forms the axis of rotation of the rotor 12.

The housing 11 comprises front 17 and rear 18 bearings which support the stator 16. In this example, the bearings 17, 18 have a hollow form, and each support centrally a ball bearing for fitting of the shaft 13 with rotation.

More specifically, in the example in FIG. 1, the rotor 12 comprises two magnet wheels 24, 25, each of which has a flange 28 with transverse orientation provided on its outer periphery with claws 29, for example with a trapezoidal form and axial orientation. The claws 29 of one wheel 24, 25 face axially towards the flange 28 of the other wheel. The claws 29 of one magnet wheel 24, 25 penetrate into an inter-tooth space which exists between two adjacent claws 29 of the other magnet wheel, such that the claws 29 of the magnet wheels 24, 25 are imbricated relative to one another.

A cylindrical core 30 is interposed axially between the flanges 28 of the wheels 24, 25. In this case, the core 30 consists of two half cores, each belonging to one of the flanges 28. This core 30 supports an excitation rotor winding 31 on its outer periphery.

The shaft 13 can be forced into the central bore in the magnet wheels 24, 25. On its front end side, the shaft 13 can comprise a threaded part for securing of a pulley 35. The pulley 35 belongs to a movement transmission device with at least one belt between the alternator 10 and the thermal engine of the motor vehicle.

The rear bearing 18 supports a brush-holder 38 provided with brushes 39 which are designed to rub against rings 40 of a collector 41, in order to ensure the supply of the winding of the rotor 12.

In addition, the stator 16 comprises a body 43 in the form of a set of metal plates provided with notches equipped with notch insulation for fitting of the phases of the stator 16. Each phase comprises at least one phase winding which passes through the notches in the stator body 43, and forms with all the phases a front chignon 46 and a rear chignon 47 on both sides of the stator body 43.

The phase windings are obtained for example from a continuous wire covered with enamel, or from conductive elements in the form of pins connected electrically to one another for example by welding. The phase windings are connected electrically to electronic power modules 50 via their phase output. These power modules 50 shown in FIG. 3 form a voltage rectifier bridge in order to transform the alternating voltage generated by the alternator 10 into a direct voltage, in order in particular to supply power to the battery and the on-board network of the vehicle.

Each power module 50 comprises a control unit, which can control a plurality of bridge arms, in particular two or three bridge arms, each comprising two rectifier elements. The rectifier elements are switches constituted for example by transistors of the MOSFET type.

Connection terminals 53 are associated with the different power modules 50, for the interconnection with the tracks of a connector 55 described in greater detail hereinafter.

As can be seen in the example in FIG. 3, the power modules 50 are integrated in a heat dissipater 58, i.e. they are each positioned inside a corresponding receptacle 59 provided in the heat dissipater 58. Advantageously, the heat dissipater 58 comprises a plurality of fins 60 which extend projecting from the outer face of the body of the dissipater 58.

The connector 55 establishes electrical connections in particular between the terminals 53 of the power modules 50 and phase outputs of the alternator 10. The connector 55 also establishes electrical connections between the components of the power modules 50 and the positive potential via a positive terminal B+ with the reference 62. The positive terminal 62 is for example disposed on the heat dissipater 58. In addition, the connector 55 also establishes electrical connections between the components of the power modules 50, and an earth of the vehicle, in particular via the rear bearing 18.

For this purpose, as illustrated in FIG. 4, the connector 55 comprises a body 65 in the general form of a plate made of insulating material, over-moulded on an assembly of conductive tracks 54, some of which are represented in broken lines. The connections between the terminals 53 of the power modules 50 and the tracks 54 are formed for example by laser welding through the welding areas 68.

As can be seen in FIGS. 2, 3 and 4, some tracks 54 project radially towards the exterior of the body of the connector 65, whilst being arranged at their free ends in the form of connection lugs 71, in order to establish the connection with the phase outputs of the stator winding.

The connector 55 is secured on the heat dissipater 58 by means of connection means such as screws 74, each ensuring a mechanical and electrical connection between a track 54 of the connector 55 and the heat dissipater 58. For this purpose, the screws 74 pass through corresponding openings 77 in the connector 55, as shown in FIG. 4. These openings 77 are defined by eyelets 78 with an annular form obtained from the tracks 54 of the connector 55. As can be seen in FIG. 6, these openings 77 are positioned facing tapped holes 80 in the dissipater 58 which receive the threaded ends of the screws 74. In this example, the screw heads 83 are received in receptacles 84 provided in the body 65 of the connector 55, such as to be supported on a corresponding eyelet 78 delimiting the base of the receptacle 84. Each receptacle can be surrounded by a low wall 67 extending projecting from the body 65. The receptacle which is associated with the low wall permits better insulation of the connection means.

The subassembly formed by the connector 55 and the heat dissipater 58 is secured on the rear bearing 18 of the electrical machine for example by means of screws or bolts 87 establishing a connection between the tracks 54 of the connector 55 and an earth of the rotary electrical machine, as shown in FIG. 2. For this purpose, the screws or bolts 87 pass through corresponding openings in the connector 55 with the reference 88 in FIG. 4. Insulating shanks positioned around the screws 74 can be provided in order to prevent any short-circuits.

In order to ensure the cooling of the alternator, blades 90 are fitted integrally in rotation on the axial ends of the rotor 12, in order to ensure circulation of air in the interior of the alternator 10, as shown in FIG. 1. In order to prevent the recirculation of the hot air exiting from the machine towards the interior of the machine, an airflow anti-loopback element 93 is used which is designed to shut partially the inlets 94 provided in the rear bearing.

The airflow anti-loopback element 93 is interposed axially between the rear bearing 18 of the machine and the connector 55. As represented in the example in FIGS. 5a and 5b, the element 93 has a form of an annular plate provided with a central opening 96. On the outer periphery, cut-outs 97 are provided for the passage of the phase outputs, for their connection with the connection lugs 71. Through holes 98 provided between the inner periphery and the outer periphery of the element 93 permit in particular the passage of the screws or bolts 87 for connection to the earth. An axially projecting low wall 99 can extend locally in the vicinity of the outer periphery of the element 93.

As illustrated by FIG. 6, the airflow anti-loopback element 93 additionally comprises closure studs 101 which are each designed to close a receptacle 84 of the screw head 83 provided in the connector 55. The airflow anti-loopback element 93 can also comprise studs 101′ for closure of the welding areas 68.

As can be seen in FIG. 5a, the studs 101, 101′ can for example have a cylindrical form with curved end faces. The studs 101, 101′ are preferably made of a resilient material, in particular a polymer material.

Preferably, a height L1 measured axially of the closure studs 101 in the non-compressed state, i.e. when the studs 101 are not compressed between the bearing 18 and the body 65 of the connector 55, is greater than a height of the closure stud 101 in the compressed state, i.e. when the studs 101 are compressed between the bearing 18 and the body 65 of the connector 55. In other words, once the rotary electrical machine has been fitted, the studs 101 are compressed.

Preferably, the height L1 of the closure stud 101 in the non-compressed state is between 20 and 40% greater, and in particular 30% greater than the corresponding height of the closure stud 101 in the compressed state.

In addition, a radius L2 of the closure studs 101 is advantageously greater than a radius of the receptacle 84 of the screw head 83. The radius L2 of the closure stud 101 is greater, by a length of between 0.5 and 2 mm, in particular 1.5 mm, than the radius of the receptacle 84 of the screw head 83.

The dimensions of the closure studs 101′ in the non-compressed state are analogous to the dimensions of the corresponding welding areas 68.

The closure studs 101, 101′ can be added on and secured on the airflow anti-loopback element 93, for example by adhesion, riveting, or snapping-on. Alternatively, the airflow anti-loopback element 93 is over-moulded on the closure studs 101, 101′.

As illustrated by FIG. 5b, the closure studs 101 can also be connected to one another such as to form a seal 104. This seal 104 comprises a plurality of closure studs 101, 101′ and of connection portions 105 which ensure the connection between the adjacent studs 101, 101′. Certain connection portions 105 can follow the contour of the through holes 98.

The seal 104 can be integral with the airflow anti-loopback element 93, such as to form a bi-material part. As a variant, the seal 104 can be added on or over-moulded with the airflow anti-loopback element 93.

As a variant, one of the power modules 50 which is integrated in the dissipater is replaced by a regulation module of the brush-holder.

It will be appreciated that the foregoing description has been provided purely by way of example, and does not limit the field of the invention, a departure from which would not be constituted by replacing the different elements by any other equivalents.

In addition, the different characteristics, variants, and/embodiments of the present invention can be associated with one another according to different combinations, provided that they are not incompatible or mutually exclusive.

1. A rotary electrical machine for a motor vehicle, comprising:
a heat dissipater provided with at least one receptacle;
an electrical module which is positioned in the receptacle, and comprises at least one connection terminal;
a connector comprising at least one track which is connected electrically to the connection terminal, and a receptacle which is receives a connection means comprising a head of a screw, ensuring a mechanical and electrical connection between the track of the connector and the heat dissipater; and
an airflow anti-loopback element interposed between a bearing of the rotary electrical machine and the connector,
wherein the airflow anti-loopback element comprises at least one stud for closure of the receptacle of the connection means.

2. The rotary electrical machine according to claim 1, wherein the connector comprises at least one area of welding with the connection terminal of the electrical module, with the airflow anti-loopback element comprising at least one stud for closure of the welding area.

3. The rotary electrical machine according to claim 1, wherein the closure stud is made of a resilient polymer material.

4. The rotary electrical machine according to claim 1, wherein a height of the closure stud in the non-compressed state is greater than a height of the closure stud in the compressed state.

5. The rotary electrical machine according to claim 4, wherein the height of the closure stud in the non-compressed state is between 20% and 40% greater, than the height of the closure stud in the compressed state.

6. The rotary electrical machine according to claim 1, wherein a radius of the closure stud is greater than a radius of the receptacle of the connection means.

7. The rotary electrical machine according to claim 6, wherein the radius of the closure stud is greater, by a length of between 0.5 and 2 mm, than the radius of the receptacle of the connection means.

8. The rotary electrical machine according to claim 1, wherein that the airflow anti-loopback element is over-moulded on the closure stud.

9. The rotary electrical machine according to claim 1, wherein the closure stud is added on and secured on the airflow anti-loopback element.

10. The rotary electrical machine according to claim 1, wherein the closure stud is integral with the airflow anti-loopback element to form a bi-material part.

11. The rotary electrical machine according to claim 1, wherein the airflow anti-loopback element comprises a plurality of closure studs, which are connected to one another such as to form a seal.

12. The rotary electrical machine according to claim 1, wherein the connector comprises a low wall which extends around the receptacle that receives the connection means.

13. The rotary electrical machine according to claim 1, wherein the heat dissipater is connected to a positive potential of a battery.
